(19) United States
(12) Patent Application Publication
(10) Pub. No.: US 2017/0070555 A1
(43) Pub. Date: Mar. 9, 2017

(54) VIDEO DATA FLOW COMPRESSION METHOD

(71) Applicant: STMicroelectronics (Grenoble 2) SAS, Grenoble (FR)

(72) Inventors: Dario Frello, Sassenage (FR); Olivier Schneider, Grenoble (FR)

(21) Appl. No.: 15/067,001

(22) Filed: Mar. 10, 2016

(30) Foreign Application Priority Data
Sep. 4, 2015 (FR) 1558240

(51) Int. Cl. H04L 29/06; H04N 19/196; H04N 19/50; H04N 19/182

(52) U.S. Cl. CPC H04L 65/607; H04N 19/182; H04N 19/196; H04N 19/50

(57) ABSTRACT

A method of compressing a video image flow is disclosed. In the method, compression parameters are adapted according to at least one compression criterion wherein the compression criterion is evaluated for each image. The compression criterion is selected from among space complexity, time complexity, and the ratio of the number of intra-image predictions to the number of inter-image predictions.

This application claims the priority benefit of French Patent application number 15/58240, filed on Sep. 4, 2015, the content of which is hereby incorporated by reference in its entirety to the maximum extent allowable by law.

### BACKGROUND

The present disclosure relates to a video data flow compression method.

### Discussion of the Related Art

Video compression methods aim at decreasing the quantity of data representative of a video while reducing the impact on the quality of the video.

Standardized compression methods such as H.264 (MPEG-4 AVC) and H.265 (MPEG HEVC) are known, which provide compressed videos in formats adapted to the storage and to the broadcasting of videos, particularly of high-definition videos. Such compression methods decrease the quantity of data by suppressing redundant data. To achieve this, the data of an area of an image of the video are predicted based on data from another area of this same image (intra-image prediction) or based on data from an area of one or a plurality of other images of the video, associated with one or a plurality of motion vectors (inter-image prediction).

The video data are compressed by a hardware and/or software encoder as the video data flow is being supplied to the encoder. In receive mode, the video data are decompressed by a corresponding hardware and/or software decoder, as the compressed video data flow is being received. The transmission of the flow of compressed video data from the encoder to the decoder may take a variety of forms, for example, the Hertzian terrestrial digital television broadcasting network, telephone networks, the Internet, etc.

In known video compression methods, compression parameters, or options, are set at the beginning of the compression of the video data flow. These parameters are determined according to target performances.

Such an operation has various disadvantages, at least some of which are intended to be overcome by the present disclosure.

### SUMMARY

Thus, an embodiment provides a method of compressing a video image flow, wherein compression parameters are adapted according to at least one compression criterion evaluated for each image and selected from among space complexity, time complexity, and the ratio of the number of intra-image predictions to the number of inter-image predictions.

According to an embodiment, a difference between measured compression performances and target compression performances is calculated.

According to an embodiment, the evaluation of a compression criterion comprises calculating a value representative of the criterion and comparing the representative value with a threshold.

According to an embodiment, the threshold is adapted according to said difference.

According to an embodiment, the compression parameters are adapted according to said difference.

According to an embodiment, the threshold is adapted according to said at least one criterion evaluated for each image.

According to an embodiment, each image is divided into pixel blocks and each of said blocks is subdivided into pixel sub-blocks, said at least one criterion being evaluated for at least some of said blocks.

According to an embodiment, the compression parameters of a block are adapted according to said at least one criterion evaluated for the block.

According to an embodiment, the compression criteria further comprise the partitioning cost.

According to an embodiment, the intra-image and/or inter-image predictions are performed for only some of the sub-blocks subdividing a block, said some sub-blocks being selected according to said at least one compression criterion evaluated for the block and according to the dimensions of said some sub-blocks.

Another embodiment provides a calculation device capable of implementing the above-mentioned method, comprising: at least one processing device; an instruction memory capable of storing computer program instructions; and at least one input/output interface.

The foregoing and other features and advantages will be discussed in detail in the following non-limiting description of specific embodiments in connection with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. One or more embodiments are described hereinafter with reference to the accompanying drawings in which:

FIG. 1 is a block diagram of a calculation device capable of performing a video compression;

FIG. 2 is a flowchart illustrating steps of a video compression method;

FIG. 3 is a flowchart illustrating steps of an embodiment of a video compression method; and

FIG. 4 illustrates acts of a variation of the method of FIG. 3.

### DETAILED DESCRIPTION

The same elements have been designated with the same reference numerals in the different drawings. Unless otherwise specified, the term “substantially” means to within 10%, preferably to within 5%.

In the following description, reference will mainly be made to the High Efficiency Video Coding (HEVC) standardized compression method or standard. This standard is also called Moving Pictures Experts Group (MPEG) HEVC standard, bearing reference ISO/IEC 23008-2. The specifications of this standard are for example published with title “High Efficiency Video Coding (HEVC) text specification draft 10 (for FDIS & Consent)”, B. Bross et al., Joint Collaborative Team on Video Coding (JCT-VC), document JCTVC-K1003, 12th Meeting: Geneva, CH, Jan. 14-23, 2013. A document disclosing an overview of this standard is entitled “Overview of the High Efficiency Video Coding (HEVC) Standard”, G. Sullivan et al., a preliminary version of which appears in “IEEE Trans. on circuits and systems for video technology”, December 2012. The content of the two above documents is incorporated herein by reference to the maximum extent allowable by law.

It should be clear to those skilled in the art that the embodiments described hereafter may also apply to other compression methods, for example, to standardized compression method H.264. Further, these embodiments may be implemented in hardware and/or software fashion.

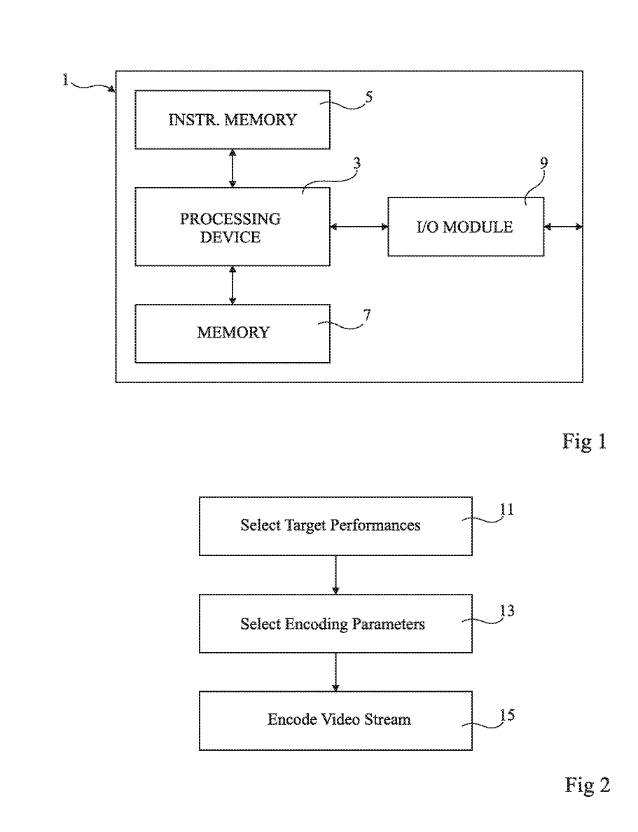

FIG. 1 is a block diagram of an example of a calculation device 1 capable of implementing a video compression method.

Calculation device 1, for example, comprises one or a plurality of processing devices 3 (PROCESSING DEVICE), for example, one or a plurality of processors and/or microprocessors. Processing device 3 is, for example, controlled by an instruction memory 5 (INSTR. MEMORY) storing program instructions. When these instructions are executed, for example, by processing device 3, they implement acts of a video compression method. In alternative embodiments, the functions of calculation device 1 are implemented by hardware means.

Calculation device 1 may also comprise one or a plurality of storage devices 7 (MEMORY) which may be coupled to processing device 3 and temporarily storing video data and/or data calculated during the compression of a video.

Further, calculation device 1 comprises one or a plurality of input/output interfaces 9 (I/O MODULE) which may be coupled to processing device 3.

FIG. 2 schematically illustrates steps of an example of a video data flow compression method implemented, for example, by the calculation device of FIG. 1.

At 11, an encoder implementing the video compression method receives first data from a video flow to be compressed. Target compression performances are selected (Select Target Performances) by a customer, or user, according to a targeted application, for example, the high-definition television broadcasting of a sports event. The target compression performances, for example, correspond to the format of the video to be compressed, in particular to the definition of the video, to the minimum target flow of compressed images, and to the maximum target flow of compressed data that the encoder should respect.

At 13, compression parameters, or options, of the encoder are selected (Select Encoding Parameters) based on the target compression performances. Indeed, the compression parameters of the encoder enable the definition of a compromise between the compression performances and the compression quality of the encoder. The compression quality corresponds to the visual rendering of the video once decompressed. A modification of the compression parameters causes an improvement of the compressing quality and a decrease in compression performances, or conversely. The compression parameters depend on the implemented video compression method. For example, when the standardized MPEG HEVC compression method is used, the compression parameters comprise:
the activation or the deactivation of the chrominance estimation;
the maximum length and the maximum accuracy of the motion vectors;
the number of evaluations performed for the merging of the motion vectors;
the maximum dimension of blocks of the image;
the minimum dimension of sub-blocks;
the size of the discrete cosine transform;
the type and the number of filters; and/or
the number of bits of each colorimetric component.

The above list of compression parameters is not exhaustive. For the MPEG HEVC standard, the compression parameters are linked to the decompression parameters of the decoder which are listed in the previously-described documents.

In practice, the compression parameters of an encoder are not selected one by one, but are predefined with respect to target compression performances corresponding, for example, to a compression level and profile. With the example of the MPEG HEVC standard, profile “Main 10” and level 4 may be selected to compress a video having a definition of 1,280 pixels by 720 pixels with a minimum flow rate of 68 images per second and a maximum data flow of 30 kbits per second.

At 15, the video data flow is compressed by the encoder (Encode Video Stream) with the parameters selected at 13 and the encoder generates a compressed video data flow.

In such a compression method, the parameters are set independently from the content of the video, and so as to respect target compression performances whatever the content of this video.

A disadvantage is that the compression quality and the compression performances are not linked to the content of the different scenes of the video to be compressed.

It is provided to modify the compression parameters of a video compression method according to the content of the scenes of the video to be compressed to increase the compression quality and/or the compression performances.

For this purpose, compression criteria such as the partitioning cost, the space complexity, the time complexity, and the ratio of the number of intra-image predictions to the number of inter-image predictions are used as a basis. Such criteria provide information relative to the content of the scenes of the video to be compressed.

The partitioning cost of an image pixel block corresponds to the block compression cost and depends on the way in which this block is recursively subdivided into sub-blocks.

The space complexity of a video image is a criterion representative of the quantity of information contained in each image pixel block, and of the way in which this information is distributed in the block.

The time complexity of a video image is a criterion representative of the motion of the image pixels relative to corresponding pixels of other images of the video. In particular, this criterion indicates whether the pixels of a block are moving in substantially identical directions or in different directions.

The ratio of the number of inter-image predictions to the number of intra-image predictions, or inter-intra ratio, is a criterion representative of the way in which the pixels of each block of an image are predicted, particularly if these pixels are predicted as a majority from the pixels of the neighboring blocks or from the pixels of other images of the video associated with motion vectors.

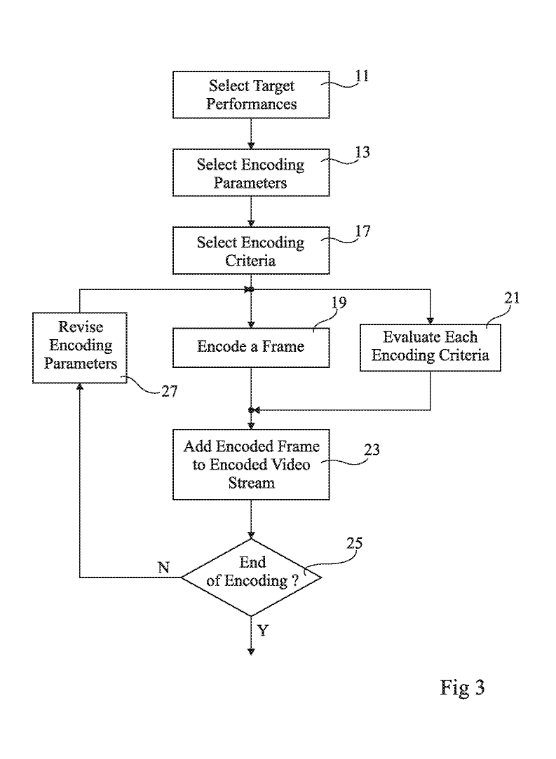

FIG. 3 is a flowchart illustrating acts of an embodiment of a video compression method.

Similar to the method described in relation with FIG. 2, the method of FIG. 3 comprises act 11 of selecting the target performances and act 13 of selecting the compression parameters based on the target performances.

At 17, at least one compression criterion (Select Encoding Criteria) is selected from among space complexity, time complexity, the partitioning cost, and the inter-intra ratio.

Two acts 19 and 21, respectively of image compression (Encode a Frame) and of evaluation of compression criteria (Evaluate Each Encoding Criteria), are then executed in parallel.

Act 19 of image compression comprises dividing the image into blocks of a largest dimension and recursively subdividing each block into sub-blocks having smaller and smaller dimensions. As an example, in the MPEG HEVC standard, each block is shown in the form of a quadtree CTB (“Coding Tree Block”), and each sub-block corresponds to a unit to be compressed CU (“Coding Unit”).

The “depth of division” of a block designates the number of different dimensions of sub-blocks used to subdivide the block. For example, a block of 64 pixels by 64 pixels divided with a depth of 2 may be divided into sub-blocks of 32 pixels by 32 pixels, which may themselves be divided into sub-blocks of 16 pixels by 16 pixels. “Partition” is used to designate a block or a sub-block of an image.

The pixels of each partition of the image are then predicted by evaluating a plurality of intra-image and inter-image prediction modes for this partition, the evaluated prediction modes depending on the compression parameters. One of the evaluated prediction modes is then selected to compress the partition, for example, based on the value of the rate-distortion optimization (RDO) calculated for each evaluated prediction mode.

As an example, in the case of the MPEG HEVC standard, during the intra-image prediction of the pixels of a partition, different intra-image prediction modes may be evaluated, that is, the planar, average, or angular mode, the angular mode being capable of withstanding up to 33 prediction directions including the vertical mode and the horizontal mode. In the inter-image prediction of the pixels of a partition, the number of evaluated inter-image prediction modes especially depends on the number of images used to search for a reference partition, on the maximum length, and on the number of motion vectors capable of merging in each partition.

Act 21 of evaluating the compression criteria selected at 17 is carried out on the image compressed at 19.

The space complexity of the image is evaluated from the space complexity of each of the image blocks. To achieve this, during the evaluation of the intra-image prediction modes of each block, the space complexity of the block is evaluated by measuring or by calculating a value representative of the space complexity of this block. This value representative of the space complexity is then compared with at least one first threshold to determine whether the block is spatially complex, that is, whether it corresponds to an area of the image comprising many details, or if the block is spatially simple, that is, whether it corresponds to a homogeneous area of the image. The number of spatially complex blocks and the number of spatially simple blocks of the image are then compared with at least one second threshold to determine whether the image is spatially complex, that is, whether it mainly comprises areas comprising many details, or is spatially simple, that is, whether it mainly comprises homogeneous areas.

As an example, the space complexity of a block is evaluated by calculating the difference between the smallest sum of absolute differences, or SAD, of the block for the simple intra-image prediction modes (planar, average, and possibly horizontal and vertical) and the smallest sum of absolute differences (SAD) of the block for all the evaluated intra-image prediction modes. If this difference is greater than a threshold THR_COMPLEX_BLOC, the block is spatially complex and is marked as COMPLEX. If the difference is smaller than a threshold THR_FLAT_BLOC, the block is spatially simple and is marked as FLAT. If the difference is between THR_COMPLEX_BLOC and THR_FLAT_BLOC, the block is not marked. Advantageously, values SAD have been calculated on evaluation of the intra-image prediction modes of the block. Thus, calculating the space complexity of a block only requires little additional time and calculation power. The image is spatially complex and is marked as COMPLEX_FRAME if the number of blocks COMPLEX is greater than a threshold THR_COMPLEX_FRAME. Similarly, the image is spatially flat and is marked as FLAT_FRAME if the number of blocks FLAT is greater than a threshold THR_FLAT_FRAME.

The time complexity of the image is evaluated similarly to the space complexity. During the evaluation or the inter-image prediction modes of each block of the image, a value representative of the time complexity of the block is measured or calculated. This value representative of the time complexity is then compared with at least one third threshold to determine whether the block is temporally homogeneous, that is, whether the block pixels displace substantially identically with respect to the pixels of a reference block of another image, for example, in the same direction and with the same speed, or whether the block is temporally inhomogeneous, that is, whether the pixels of the block displace in different directions with respect to the pixels of the reference block. The number of temporally homogeneous blocks and the number of temporally inhomogeneous blocks of the image are then compared with at least one fourth threshold to determine whether the image is temporally homogeneous or temporally inhomogeneous.

As an example, the time complexity of a block is evaluated by calculating the number of coherent motion vectors of the block, two motion vectors of a block being coherent if their directions and their lengths are substantially equal. If this number is greater than a threshold THR_MOTION, the block is temporally homogeneous and is marked as HOMOGENEOUS. Otherwise, the block is temporally inhomogeneous and is marked as INHOMOGENEOUS. The image is temporally homogeneous and is marked as HOMOGENEOUS_FRAME if the number of blocks HOMOGENEOUS is greater than a threshold THR_HOMOGENEOUS_FRAME. Similarly, the image is temporally inhomogeneous and is marked as INHOMOGENEOUS_FRAME if the number of blocks INHOMOGENEOUS is greater than a threshold THR_INHOMOGENEOUS_FRAME.

The evaluation of the time complexity of the image may further comprise a step comprising calculating length difference DIFF_MV between the maximum length of the motion vectors, defined by the compression parameters, and that of the longest motion vector used to predict the image pixels.

The evaluation of the inter-intra ratio for example comprises calculating the ratio of the number of predicted partitions of the image according to an inter-image prediction mode and the number of predicted partitions of the image according to an intra-image prediction mode.

At 23, the compressed data representative of the image are added to the compressed video data flow (Add Encoded Frame to Encoded Video Stream).

A test at 25 (End of Encoding?) is then carried out to verify whether all the images of the video have been compressed.

If all the images of the video have been compressed (output Y of block 25), the video flow compression method is over.

If one or a plurality of images of the video have not been compressed yet (output N of block 25), the compression parameters may be adapted (Revise Encoding Parameters) at 27. The compression parameters are modified based on the evaluation of the compression criteria, and thus on the content of the image which has just been compressed. The modified compression parameters are used for the next compressions of images of the video, at 19.

Taking the previous example, in the case where the image is marked as COMPLEX_FRAME, the evaluation of the inter-image prediction modes of the partitions of large dimensions, for example, greater than 32 pixels by 32 pixels, may be deactivated. Further, the estimation of the chrominance and/or of certain filters may be deactivated. The deactivation of the chrominance only causes a substantially negligible decrease of the compression quality due to the fact that the human vision system, or HVS, is less sensitive to artifacts, or block effects, in an image comprising many details. Such modifications of the compression parameters cause a decrease in the calculation power used for the next image compressions, and thus a decrease in the duration of the next image compressions. This results in an improvement of the compression performance. In the case where the image is marked as FLAT_FRAME, the estimation of the chrominance and/or certain filters may be activated to improve the quality of the compression, and/or the depth of division may be decreased to improve the compression performances.

In the case where the image is marked as HOMOGENEOUS_FRAME, the number of evaluations performed for the merging of the motion vectors and/or the accuracy of the evaluation of the motion vectors may be increased to improve the quality of the next image compressions. In the case where the image is marked as INHOMOGENEOUS_FRAME, the values of the above-mentioned compression criteria may be decreased to improve the compression performances. Further, in the case where value DIFF_MV has been calculated and is greater than a threshold THR_DIFF_MV, the maximum length of the motion vectors may be decreased to improve the performances of the next image compressions with a negligible effect on the compression quality.

In the case where the inter-intra ratio is greater than a threshold THR_INTER, the compression parameters may be adapted to favor the inter-image predictions of the image partitions. When the inter-intra ratio is smaller than a threshold THR_INTRA, the compression parameters may be adapted to favor the intra-image predictions of the image partitions.

Due to the fact that the compression parameters are modified according to the content of an image of a video scene and that the images of a same video scene generally have a similar content, the modified parameters are then adapted to the content of the other images in this scene. This results in an improvement of the compression performances and/or of the quality of the compression of this video scene.

In a variation of the method of FIG. 3, it is further provided for certain compression parameters to be modified, at 19, during the compression of a block. It may also be provided to deactivate the evaluation of the inter-image and/or intra-image prediction modes for certain dimensions of sub-blocks subdividing this block. For this purpose, the space complexity and/or the time complexity and possibly the partitioning cost evaluated for this block are used as a basis. This enables adaptation of the compression of the block according to the content thereof.

In the previous example, a block of 64 pixels by 64 recursively subdivided into sub-blocks is considered.

During the evaluation of the intra-image prediction modes, in the case where the block is marked as FLAT, the evaluation of the intra-image prediction modes may be deactivated for the sub-blocks of the block having small dimensions, for example, smaller than or equal to 16 pixels by 16 pixels. In the case where the block is marked as COMPLEX, the evaluation of the intra-image prediction modes may be deactivated for the sub-blocks of the block having large dimensions, for example greater than or equal to 32 pixels by 32 pixels.

During the evaluation of the inter-image prediction modes, in the case where the block is marked as HOMOGENEOUS, the estimation of the inter-image prediction modes may be deactivated for the sub-blocks of the block having small dimensions. In the case where the block is marked as INHOMOGENEOUS, the estimation of the inter-image prediction modes may be deactivated for the sub-blocks of the block having large dimensions. Further, independently from the fact that the block is INHOMOGENEOUS or HOMOGENEOUS, if the block is marked as FLAT, the estimation of the inter-image prediction modes may be deactivated for the sub-blocks having small dimensions.

When the partitioning cost is one of the compression criteria selected at 17, the partitioning cost of a block is evaluated for different division depths, starting with the largest division depth defined by the compression parameters. The partitioning cost of the block for a division depth X, with X being an integer from 1 to 4 in the case of the MPEG HEVC standard, is compared with the cost of the partitioning of this block for a depth of division X−1. If the difference between the partitioning costs is greater than a threshold DELTA_OPT, it is possible for the inter-image and/or intra-image prediction modes not to be evaluated for this block divided according to depths smaller than X−1. Preferably, the cost of the partitioning of a block is evaluated when the block has not been marked during the evaluation of the space complexity and/or the time complexity.

In this variation, to compress a block, the evaluation of the intra-image and/or inter-image prediction modes is only performed for certain depths of division and/or for certain dimensions of the sub-blocks subdividing the block. This results in a decrease of the block compression time, and thus an improvement of compression performances. Further, the impact on the compression quality is negligible due to the fact that the evaluation of the inter-image and/or intra-image prediction modes is only deactivated for the sub-blocks comprising the least information.

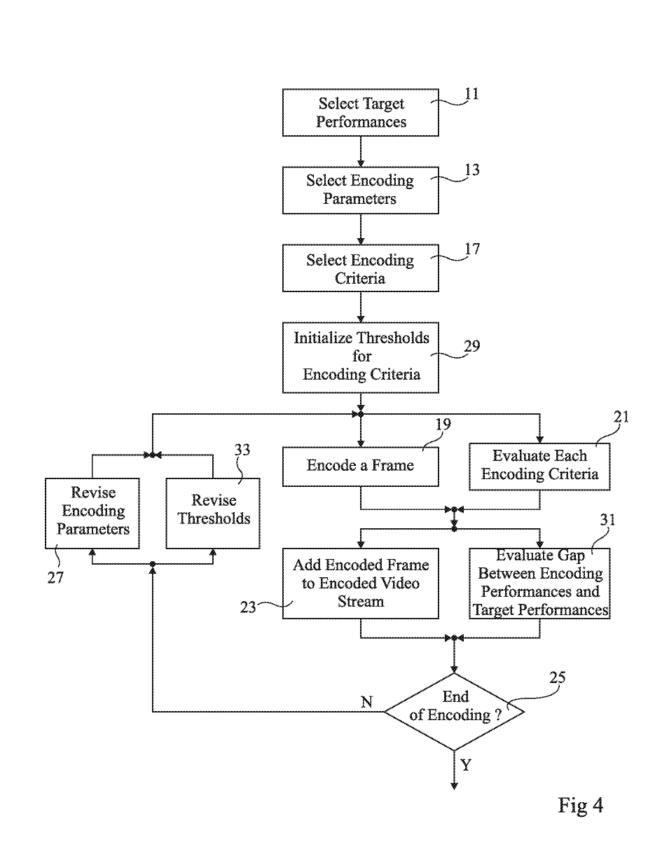

FIG. 4 illustrates acts of another variation of the method of FIG. 3 where it is provided to modify the compression parameters and/or the values of the thresholds associated with the compression criteria according to the evaluation of the compression criteria and possibly to the difference between the real or measured compression performances and the target performances.

In this variation, similar to the method described in relation with FIG. 3, target performances are selected at 11, compression parameters are selected at 13 based on the target performances, and at least one compression criterion is selected at 17.

At 29, the thresholds associated with the selected criteria are initialized (Initialize Thresholds for Encoding Criteria). The initial value of a threshold may be fixed or depend on the application.

For example, the initial values of thresholds THR_COMPLEX_FRAME, THR_FLAT_FRAME, THR_HOMOGENEOUS_FRAME, and THR_INHOMOGENEOUS_FRAME may increase or decrease based on the definition of the video to be compressed to take into account the fact that the number of blocks of an image increases or decreases when the definition of the image increases or decreases.

After 29, the acts at 19 and 21 are carried out on an image of the video as described in relation with FIG. 3. At 23, the compressed data representative of this image are added to the compressed data flow.

At 31, carried out in parallel with the acts at 23, the compression performances of the encoder are measured and the difference with the target compression performances is calculated (Evaluate Gap Between Encoding Performances and Target Performances). For example, the encoder calculates the difference between the measured and target flow rates of compressed data and/or the difference between the measured and target compressed image flow rates.

After the acts at 23 and 31, a test at 25 is carried out. If there remain images to be compressed (output N of block 25), the compression parameters may be adapted at 27, possibly according to the difference between the real and target performances.

At 33 carried out in parallel with the acts at 27, threshold values associated with the compression criteria may be modified (Revise Thresholds) by taking into account the evaluation of these criteria.

In the examples described in relation with FIG. 3, an increase in the value of threshold THR_FLAT_BLOC causes an increase in the number of blocks marked as FLAT_BLOC per image during the next image compressions. This results in a decrease of the compression time and/or of the compressed data flow rate. So that the increase in the value of threshold THR_FLAT_BLOC only causes a substantially negligible decrease in the compression quality, that is, a decrease of less than 10%, preferably of less than 5%, the increase of the number of blocks marked as FLAT_BLOC in the next compressed images may be compared with the increase of the value of threshold THR_FLAT_BLOC. The value of threshold THR_FLAT_BLOC may be decreased if these increases are not correlated.

Similarly, a decrease in the value of threshold THR_COMPLEX_BLOC causes an increase in the number of blocks marked as COMPLEX_BLOC per image in the next image compressions, and thus an improvement of compression performances. In the same way as for threshold THR_FLAT_BLOC, the correlation between the decrease in the value of threshold THR_COMPLEX_BLOC and the increase in the number of blocks marked as COMPLEX_BLOC per image is studied. When these variations are not correlated, the value of THR_COMPLEX_BLOC is adjusted to decrease the impact of the modification of threshold THR_COMPLEX_BLOC on the compression quality.

The value of threshold DELTA_OPT relative to the partitioning cost may be increased, particularly when the number of non-marked blocks of an image of a video scene is significant, for example, greater than 30% of the total number of image blocks. This causes a decrease in the compression time during next compressions of images of this video scene, and thus of the compressed data flow. This results in an improvement of compression performances.

At 33, the modifications of the threshold values may also be performed by taking into account the performance differences measured at 31. For example, the increase of the value of threshold THR_FLAT_BLOC, the increase of value DELTA_OPT, and/or the decrease of the value of threshold THR_COMPLEX_BLOC may be carried out when the compressed data flow measured at 31 is equal, for example, to within 5%, to the target flow of compressed data, and/or when the image flow measured at 31 is smaller, for example, by more than 5%, than the target compressed image flow.

Due to the fact that the threshold values are modified by taking into account, for a plurality of compressed images, the evaluation of the compression criteria and the performance differences calculated at step 31, the measured performances converge towards the target performances, independently from the initial values of the thresholds.

Tests have shown that, in the case where a first encoder and a second encoder implement the MPEG HEVC standard, if the compression method of FIG. 4 is applied to the second encoder, the second encoder may supply a twice greater image flow rate than the first encoder with a decrease of from 2 to 8% only of the compression quality, or provide a twice greater compression quality than the first encoder with substantially identical compression performances. Favoring the compression quality or the compression performances particularly depends on the selection of the compression parameters which are modified and on the nature of the performed modifications.

Specific embodiments have been described. Various alterations, modifications, and improvements will readily occur to those skilled in the art. In particular, to improve the compression performances and/or quality, it will be within the abilities of those skilled in the art to perform other compression parameter modifications than those previously described, based on the evaluation of the compression parameters and possibly on the difference between the measured compression performances and the target compression performances.

Although examples of values representative of the compression criteria have been described, other values may be used. For example, the space complexity may be evaluated based on equations (1) and (3) of article “IMAGE COMPLEXITY AND SPATIAL INFORMATION” of Honghai Yu and Stefan Winkler, disclosed in 2013 in “Fifth International Workshop on Quality of Multimedia Experience (QoMEX)”.

The order and the number of the acts described in relation with FIGS. 3 and 4 may be modified by those skilled in the art. For example, an additional act of detecting the change of content in a video being compressed may be provided. It may also be provided to modify the selection of the compression criteria and/or to reset the threshold values associated with the compression criteria, for example, when a change of content is detected. Further, instead of adding, to the compressed data flow, all the compressed data representative of an image at 23, these data may be added as the image is being compressed. In this case, the measurement of the compression performances is for example performed continuously, periodically, or after the compression of each block of the image.

Specific embodiments have been described. Various alterations and modifications will occur to those skilled in the art. In particular, although in the previously-described embodiments, optoelectronic chip 12 is directly bonded to control chip 14, optoelectronic chip 12 and control chip 14 may be each bonded to a printed circuit.

Such alterations, modifications, and improvements are intended to be part of this disclosure, and are intended to be within the spirit and the scope of the present invention. Accordingly, the foregoing description is by way of example only and is not intended to be limiting.

The various embodiments described herein can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of compressing a video image flow, comprising:
evaluating at least one compression criterion for each image in the video image flow, the at least one compression criterion selected from among space complexity, time complexity, and a ratio of a number of intra-image predictions to a number of inter-image predictions; and
adapting compression parameters for the respective image according to the at least one compression criterion that was evaluated.

2. The method of claim 1, comprising:
calculating a difference between measured compression performances and target compression performances.

3. The method of claim 2, wherein evaluating the at least one compression criterion comprises:
calculating a value representative of the at least one compression criterion; and
comparing the representative value with a threshold.

4. The method of claim 3, comprising:
adapting the threshold according to said difference.

5. The method of claim 2, comprising:
adapting the compression parameters according to said difference.

6. The method of claim 3, comprising:
adapting the threshold according to said at least one criterion evaluated for each image.

7. The method of claim 1, wherein each image in the video image flow is divided into pixel blocks and each of said pixel blocks is subdivided into pixel sub-blocks, said evaluating at least one compression criterion for each image including evaluating the at least one compression criterion for at least some of said pixel blocks.

8. The method of claim 7, wherein at least one compression parameter of a pixel block is adapted according to said evaluating at least one criterion for a selected pixel block.

9. The method of claim 7, wherein the at least one compression criterion includes a partitioning cost.

10. The method of claim 7, comprising:
performing at least one of intra-image predictions and inter-image predictions for only some of the pixel sub-blocks subdividing a pixel block, said some of the pixel sub-blocks being selected according to said at least one compression criterion evaluated for the pixel block and according to one or more dimensions of said some of the pixel sub-blocks.

11. A calculation device, comprising:
at least one processing device;
an input interface to receive an input video stream;
an instruction memory to store computer program instructions, the computer program instructions executable by the at least one processing device, the computer program instructions arranged to:
evaluate a compression criterion for each frame of a plurality of frames in the input video stream, the at least one compression criterion selected from among space complexity, time complexity, and a ratio of a number of intra-image predictions to a number of inter-image predictions; and
adapt compression parameters for each frame according to the evaluated compression criterion.

12. The calculation device of claim 11, wherein the computer program instructions are further arranged to:
calculate a difference between measured compression performances and target compression performances;
calculate a value representative of the at least one compression criterion; and
compare the representative value with a threshold.

13. The calculation device of claim 11, wherein the at least one compression criterion includes a partitioning cost.

14. The calculation device of claim 11, wherein a space complexity compression criterion includes a determination that a portion of a frame is spatially complex or spatially simple.

15. The calculation device of claim 11, wherein evaluating compression criterion for a frame includes evaluating the compression criterion for a pixel sub-block of a pixel block of the frame, the frame divided into a plurality of pixel blocks, each pixel block divided into a plurality of sub-pixel blocks.

16. A video compression method, comprising:
identifying a group of pixels of a video frame;
selecting a compression criterion, the compression criterion being one of space complexity, time complexity, and a ratio of a number of intra-image predictions to a number of inter-image predictions;
evaluating the identified group of pixels according to the selected compression criterion;
adapting compression parameters for the identified group of pixels based on the evaluation; and
performing the acts of identifying, selecting, evaluating, and adapting for a plurality of different groups of pixels of the video frame.

17. The video compression method of claim 16, wherein a space complexity compression criterion is based on a plurality intra-image prediction mode calculations.

18. The video compression method of claim 16, wherein a space complexity compression criterion includes a determination that the identified group of pixels is spatially complex or spatially simple.

19. The video compression method of claim 16, wherein the time complexity compression criterion is based on a number of coherent motion vectors associated with the identified group of pixels.

20. The video compression method of claim 16, wherein a time complexity compression criterion includes a determination that the identified group of pixels is temporally homogeneous or temporally inhomogeneous.
